(19) United States
(12) Patent Application Publication
(10) Pub. No.: US 2003/0106021 A1
(43) Pub. Date: Jun. 5, 2003

(54) Apparatus and method for creating PDF documents

(76) Inventor: Tushar Mangrola, Rancho Santa Margarita, CA (US)

Correspondence Address: Richard L. Myers, MYERS, DAWES & ANDRAS LLP, Suite 1150, 19900 MacArthur, Irvine, CA, 92612, US

(21) Appl. No.: 09/997,699

(22) Filed: Nov. 30, 2001

(51) Int. Cl. G06F 15/163; G06F 9/54; G06F 9/00

(52) U.S. Cl. 715/513

(57) ABSTRACT

A method for producing a Portable Document Format (PDF) document from data in an Extensible Markup Language (XML) includes the steps of providing an Extensible Stylesheet Language Template (XSLT) transformer having an input and an output and being adapted to respond to XSLT instructions to vary the format of data received at the input. The XML data is introduced to the XSLT transformer at the input while XSLT instructions are provided to the transformer. Responding to the XSLT instructions, the XSLT transformer varies the format of the XML data at the input and provides at the output data in a Form Document Format (FDF) format. This data can be merged into a PDF form to produce the PDF document. The PDF form can be produced by scanning in order to further facilitate this process. An associated apparatus includes the XSLT template, XSLT transformer, a PDF form reader and a printer. A scanner can be used to scan a particular form and thereby produce the PDF form.

### BACKGROUND OF THE INVENTION

1. Field of the Invention

This invention relates generally to methods and apparatus for creating Portable Document Format (PDF) documents from extensible markup language (XML) data, and more specifically to methods and apparatus for converting application data to Form Document Format (FDF) format to produce PDF documents.

2. Discussion of Related Art

XML data is presently converted in a transformer adapted to receive Extensible Style Sheet Language Template (XSLT) instructions to produce data in a hypertext markup language (HTML) format. While data in this HTML format is well suited for presentation on a screen, it is of little value in creating documents. The format of data output from the XSLT transformer can be varied with changes to the XSLT instructions, but this result has only been achieved to produce the HTML data or to convert to another XML format. For purposes of comparison, this method and apparatus will hereinafter be referred to as the XTML Process.

Present methods and apparatus for producing PDF documents take data directly from an application source and put it in a Form Document Format (FDF) to produce the PDF documents. Processors of this type have required a significant encoding effort. In spite of this substantial hurdle, the greatest drawback of this process has been the need to prepare the data in order to comply with rules of the processor. Notwithstanding these deficiencies, this process remains the primary vehicle for deriving PDF documents from application data. For purposes of comparison this method and apparatus will hereinafter be referred to as the Direct PDF Process.

More recently, application data has been fed directly to a Formatting Objects to PDF (FOP) processor which responds to XSLT templates to directly produce the PDF documents. Although this system is widely touted, it is not capable of producing highly accurate PDF documents. The FOP process does not produce an FDF data format nor is it adapted to receive a PDF form for merging purposes. As with the previous process, this FOP program also requires a high degree of coding to directly produce the PDF document. For each document desired, this coding of significant detail must be revised. For example, to merely print a check of larger size, the code must be entirely changed from that capable of printing a check of smaller size.

The FOP processor does not allow for merging. Accordingly, there is no data capable of being input to different PDF forms. Rather, the code of the FOP processor must be changed for each individual form. This change in code is typically accomplished by trial and error where the code is written, the resulting document displayed, and code changed to correct errors.

Both of these processors of the prior art require a high degree of coding to accommodate documents of different size and shape. Coding to produce documents is very difficult since it must be undertaken from scratch for each document. The FOP process does not create a form, but unfortunately creates the PDF document directly. For purposes of comparison, this apparatus and method will hereinafter be referred to as the FOP Process.

### SUMMARY OF THE INVENTION

In accordance with the present invention, these deficiencies of the past are overcome with an apparatus which is adapted to receive XML data and to convert that data in a transformer receiving XSLT instructions and templates. With appropriate changes to the XSLT instructions and templates, the transformer is capable of producing FDF data from the XML data. Thus, in accordance with the present invention, XML data can be introduced to an existing transformer along with XSLT instructions appropriate to output data in the FDF format. Given the data in this FDF format, one can now simply and inexpensively merge the FDF data with PDF forms to produce the PDF document. In this process, the PDF forms can be produced graphically using a scanner rather than relying on variations in code, produce a PDF document of highest quality.

In one aspect, the invention includes a method for producing a PDF document from XML data. The XML data is introduced to the input of the XSLT transformer, and appropriate XSLT instructions are issued to the transformer. The transformer in-turn responds to the XSLT instructions to vary the format of the XML data at the input. At the output of the XSLT transformer, the data is provided in an FDF format in accordance with the XSLP instructions.

An associated apparatus for converting data in an XML language to a PDF document includes an XSLT template and an associated XSLT transformer having an input and an output. The transformer is adapted to receive the XML data at the input and is responsive to the XSLT instructions to provide the data in the FDF format at the output. Means can then be provided to respond to the data in the FDF format to produce the PDF document. The means responsive to data in the FDF format can include means for merging the data into a PDF form to produce the PDF document. A scanner can be used to graphically produce the PDF form.

In one aspect, the invention includes a method for producing a PDF document from data in an XML language. The method can be performed using an XSLT transformer having an input and an output, and being able to respond to XSLT instructions to vary the format of data received at the input. Introducing the XML data to the XSLT transformer and providing the XSLT instructions to the transformer, enables the transformer to respond to the instructions and thereby vary the format of the XML data. Ultimately, data is output from the XSLT transformer in an FDF format. By providing a PDF form, this data in the FDF format can be input to the PDF form to produce the PDF document. The PDF form can be provided graphically for example by scanning a particular form to produce the PDF form.

In another aspect, the invention includes apparatus for converting data in an XML language to a PDF document. The apparatus includes an XSLT template and a transformer having an input and an output. The transformer is adapted to receive the XML data at the input and has properties responsive to the XSLT template to provide the data in an FDF format at the output. Means responsive to the data in the FDF format produces the FDF document. The apparatus can include means for merging the data in the FDF format into a PDF form to produce the PDF document. A standard can be used for graphically producing the PDF form.

These and other features and advantages of the invention will be more apparent with a description of preferred embodiments and reference to the associated drawings.

### DESCRIPTION OF THE DRAWINGS

FIG. 1 is a schematic diagram of one embodiment of the present invention;

FIG. 2 is a schematic diagram of a further embodiment of the present invention; and

FIG. 3 is a schematic diagram showing a preferred method of the present invention.

### DESCRIPTION OF PREFERRED EMBODIMENTS IN BEST MODE OF THE INVENTION

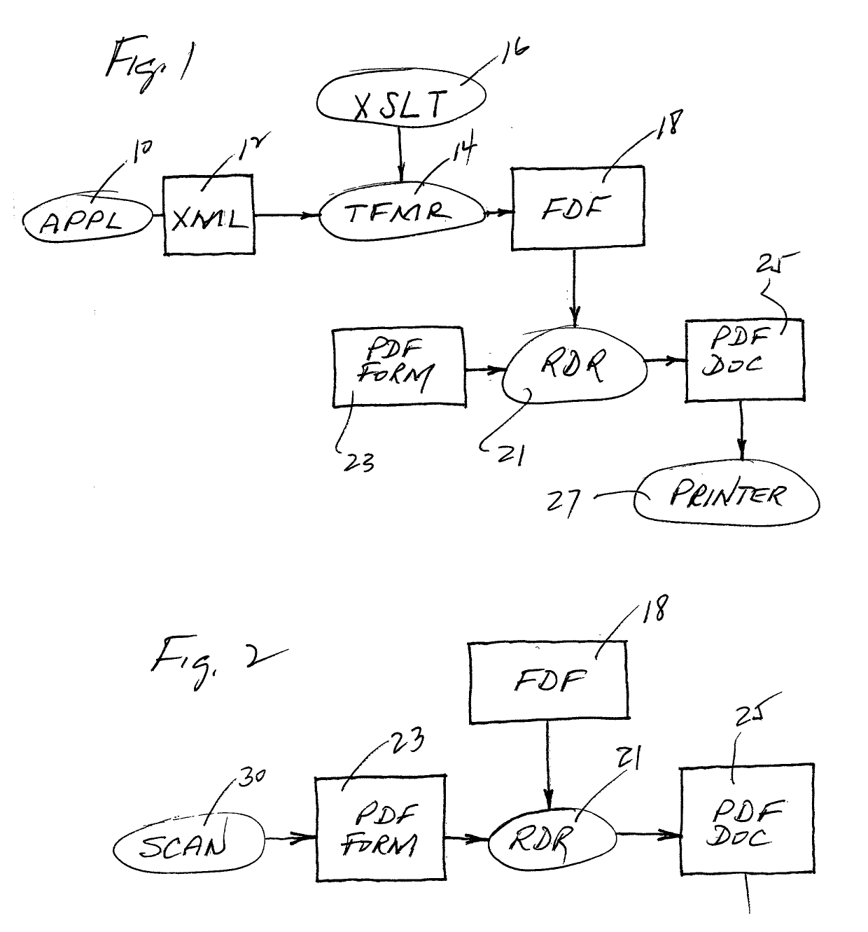

In the following description, reference will be made to schematic diagrams wherein elements of structure are generally shown in circles or ovals. These elements will generally represent structure or otherwise signify the accomplishment of some function. These elements are to be distinguished from those labels which are shown in boxes and merely indicate the language, format, or form which is present at that point in the schematic. With this understanding it will be noted that a computer application is illustrated in FIG. 1 and designated by a reference numeral 10. This application 10 could be any computer program adapted to perform a computer function. In its most common sense, the application 10 might be a word processor, for example.

The computer application 10 will typically provide an output in the form of XML data as shown by the box 12. This box 12 provides an input to an XSLT transformer 14 which also receives instructions from an XSLT template 16. The transformer 14 responds to instructions from the template 16 to provide the XML data 12 in a usable format. In the past, instructions from the XSLT template 16 directed the transformer 14 to convert the XML data 12 to an HTML format. This format is particularly adapted for presentation on a screen. However, the HTML process does not produce data which is capable of being printed.

In accordance with the present invention, illustrated in the preferred embodiment of FIG. 1, the XSLT template 16 is adjusted to provide the transformer 14 with instructions for converting the XML data 12 to a totally different format from the HTML format of the prior art. As shown in FIG. 1, the output from the transformer 14 in accordance with this invention is provided in an FDF format as shown by the box 18. This format 18 is capable of being introduced to a reader 21, for example of the type marketed by Adobe Software under the trademark ACROBAT. This reader 21 is capable of receiving data in the FDF format 18 along with a particular PDF form chosen by the user. This PDF form, illustrated in a box 23, can be of the type commonly available through Adobe software and marketed under the trademark Acrobat in FIG. 1. The output from the reader is a PDF document 25 where the data in the FDF format 18 is merged into the PDF form 23. This PDF document 25 with its form and data is capable of being reproduced in a printer 27.

In comparison to the processes of the prior art, it will be noted that the present invention relies upon much of the hardware presently available and in use to produce HTML data. However, this hardware is appropriately modified to produce an XSLT template 16 which provides appropriate instructions to the transformer 14 in order to format the XML data 12 into an FDF format 18. Thus, by comparison with the HTML process, an output is provided that is ultimately capable of being printed and is not restricted to mere presentation on a screen.

The present invention differs significantly from the Direct PDF Process. Notwithstanding the fact that the Direct PDF Process and the present invention start with XML data and end up with PDF documents, the present invention is capable of functioning with various PDF forms which facilitate merger and other processes which simply and easily provide a high degree of detail to the PDF document. This is not possible with the Direct PDF Process which merely takes the XML data, and with a significant encoding effort prepares that data to comply with rules of a PDF processor. Any change in the desired form of the PDF document is necessarily preceded with a total and significant change in the encoding required for the processor. As noted, with the present invention, data in the FDF format 18 is simply fed to a reader 21 which merges that data into a prescribed PDF form 23 to provide the PDF document 25 with a high degree of detail.

By comparison with the FOP Process of the past, the present invention does not produce a PDF document directly from XSLT templates. Rather, data in the FDF form 18 is produced which can then be merged in the manner previously discussed to provide the PDF document 25. As with the Direct PDF Process of the past, the FOP Process of the past requires a significant degree of encoding for each document desired. Even the simple change in size of the document desired requires a complete and total re-encoding of the FOP processor.

A further embodiment of the invention is illustrated in FIG. 2 where a scanner 30 is provided to produce the PDF form 23. Realizing that the PDF forms presently available are merely graphical representations of a printed format, it can now be appreciated that these different formats can also be produced using the scanner 30. Thus, a particular printing format, such as that required for a bank check, can be derived using the scanner 30. The output from the scanner 30 would then provide the PDF form 23 for input to the reader 21. Given the data in the FDF format 18, the reader 21 would incorporate the data into the PDF form 23 derived from the scanner 30, and produce the PDF document 25 for printing.

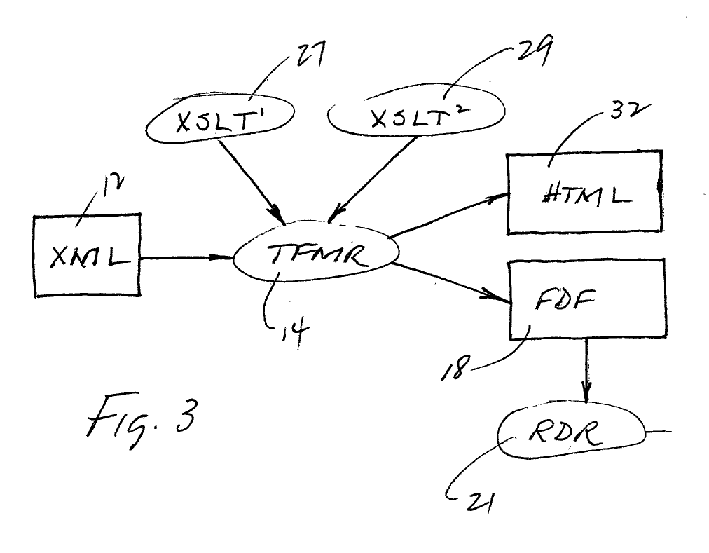

A preferred process associated with the present invention is illustrated in FIG. 3 where it is shown that the XSLT transformer 14 can be provided and adapted to receive the XML data 12. The transformer 14 is adapted to receive input from at least two XSLT templates, designated in FIG. 3 as XSLT¹ 27 and XSLT² 29. Using the XSLT¹ template 29, the transformer 14 can transform the XML data 12 into an HTML format as shown by the box 32. This part of the process is well known to produce a format capable of being displayed on a screen.

The process further illustrated in FIG. 3 enables the user to alternatively select the XSLT² template 29. With the instructions from this XSLT² template 29, the transformer 14 will convert the XML data 12 to an FDF format in the manner previously described. Note that this process does not demand any major encoding, for example of the type required by the Direct PDF Process or the FOP Process of the prior art. By merely changing the template and instructions to the XSLT transformer 14, the FDF data can be derived for printing purposes.

Taking this data in the FDF format 18 from the XSLT transformer 14 and further merging that data into the PDF form 23 provides for simple alterations in format resulting in significantly different and highly detailed PDF documents. Scanning a particular document of interest, such as a bank check in order to produce the PDF form 23 contributes significantly to the simplicity, ease and detail which can be achieved in the printed document.

It will be appreciated that in this disclosure, preferred embodiments have been discussed as examples of the underlying inventive concept. One is cautioned not to refer merely to these preferred embodiments in evaluating the extent of the concept, but rather encouraged to refer to the following claims to determine the scope of the invention.

1. A method for producing a Portable Document Format (PDF) document from data in an Extensible Markup Language (XML), comprising the steps of:
providing an Extensible Stylesheet Language Template (XSLT) transformer having an input and an output and being adapted to respond to XSLT instructions to vary the format of data received at the input;
introducing the XML data to the XSLT transformer at the input of the transformer;
providing XSLT instructions to the XSLT transformer;
responding to the XSLT instructions to vary the format of the XML data at the input; and
outputting the data from the output of the XSLT transformer in a Form Document Format (FDF) format.

2. The method recited in claim 1 further comprising the step of producing a Portable Document Format (PDF) document from the data in the FDF format.

3. The method recited in claim 2 wherein the producing step includes the steps of:
providing a PDF form; and
merging the data in the FDF format into the PDF form to produce the PDF document.

4. The method recited in claim 3 wherein the step of providing a PDF form includes the step of providing the PDF form graphically.

5. The method recited in claim 4 wherein the step of providing the PDF form graphically includes the step of scanning a particular form to produce the PDF form.

6. Apparatus for converting data in an Extensible Markup Language (XML) language to a Portable Document Format (PDF) document, including:
an Extensible Style Sheet Language Template (XSLT);
a transformer having an input and an output, the transformer being adapted to receive the XML data at the input and having properties responsive to the XSLT template to provide the data in a Form Document Format (FDF); and
means responsive to the data in the FDF format to produce a PDF document.

7. The apparatus recited in claim 6 wherein the means responsive to the data in the FDF format, comprises means for merging the data in the FDF format into a PDF form to produce the PDF document.

8. The apparatus recited in claim 7 further comprising a scanner for graphically producing the PDF form.
